(19) United States
(12) Patent Application Publication
(10) Pub. No.: US 2016/0223386 A1
(43) Pub. Date: Aug. 4, 2016

(54) FLUID LEVEL IN PRESSURE VESSEL

(71) Applicants: Stephen Martin Shaw, Rotherham (GB); Andrew Colverson, Rotherham (GB)

(72) Inventors: Stephen Martin Shaw, Rotherham (GB); Andrew Colverson, Rotherham (GB)

(73) Assignee: AES Engineering Ltd., Rotherham (GB)

(21) Appl. No.: 15/011,778

(22) Filed: Feb. 1, 2016

(30) Foreign Application Priority Data
Jan. 30, 2015 (GB) 1501604.1

(51) Int. Cl. G01G 17/06; G01G 13/30; G01G 21/28; G01G 3/00

(52) U.S. Cl. CPC G01G 17/06; G01G 3/00; G01G 13/30; G01G 21/28

(57) ABSTRACT

A mechanical seal support system includes a pressure vessel for supplying barrier fluid to a mechanical seal, a device for determining the mass of the pressure vessel and a device for providing additional barrier fluid to the pressure vessel when a determination is made that the mass of the pressure vessel is below a predetermined level responsive to the device for determining mass of the pressure vessel.

### BACKGROUND OF THE INVENTION

1. Technical Field of the Invention

The present invention relates to a method of determining the volumetric level of barrier fluid in a mechanical seal pressure vessel.

2. Description of the Prior Art

In an American Petroleum Institute (“API”) Plan 53B mechanical seal support system, a bladder is pre-charged with nitrogen to a predetermined pressure. Once it has been pre-charged with gas, it is filled with barrier fluid to the required pressure, 2 barg greater than maximum product pressure. During operation, the accumulator is isolated from the gas and the barrier fluid source.

In normal operation, it is anticipated that there will be leakage from the mechanical seal which will reduce the barrier fluid volume in the accumulator over time. It can be estimated when the barrier fluid will require refilling if the leakage rate is known. It is a common industry standard that it can be expected for the barrier fluid to require refilling every 28 days or more, although this may vary depending on the volume of barrier fluid, the seal leakage rate and alarm strategy employed. Also, due to unforeseen variations in seal performance or environmental conditions, it is sometimes not possible or inaccurate to predict and so control a need for implementation.

These controls are either in the form of pressure transmitters connected to the accumulator, which highlight when the pressure of the barrier fluid has reduced to a particular level and the accumulation needs refilling, or a combination of pressure and temperature transmitters connected to the site distribution control system (“DCS.”) The combination of a pressure and temperature transmitter is sometimes preferable due to changes in ambient temperature affecting the accuracy of the pressure readings. An algorithm in the site DCS system utilizes the readings from both the transmitters to calculate the volume of barrier fluid left in the accumulator. If a DCS is not available it has been proposed that individual single loop controllers are used on each 53B system. These two solutions can not only be expensive but also complex for the site to implement and so an alternative has been invented.

### SUMMARY OF THE INVENTION

According to the present invention, there is provided a mechanical seal support system comprising a pressure vessel for supplying barrier fluid to a mechanical seal, the pressure vessel being located on holding means which is mounted on a support structure, means mounted on the support structure for determining the mass of the vessel, and means, responsive to said determination for providing additional fluid to the vessel when the determined mass is below a pre-determined level.

In a preferred embodiment, the holding means is arranged for axial movement with respect to the support structure.

Preferably the support structure includes a cushioning member containing a fluid and means for determining the pressure of the fluid for determining the mass of the vessel.

More preferably, the mechanical seal support system of the present invention includes pipe work for connecting the pressure vessel to a mechanical seal, the pipe work including a flexible component. The flexible component may include flange plates separated by a member having O-rings providing sealing therebetween. The flexible component may also comprise a flexible hose section or may comprise a coiled pipe section.

The holding means of the mechanical seal support system may include a spring mounted support plate. The support plate may be moveable when the mass of the vessel is less than the predetermined amount, to a position where a switch member is activated to signal a requirement for additional fluid to be provided.

In another preferred embodiment of the present invention, the means for determining the mass of the vessel includes a strain gauge. The strain gauge may be located on bracketing members, which surround the vessel and/or the strain gauge may be located on the holding means.

When only the mass for the vessel is measured, it is preferred that the mass measurement device be incorporated into the system. More particularly, it is preferable that the mass measurement device be incorporated into the support structure for the vessel so that the mass of the vessel is supported fully by it.

Preferably, the present invention incorporates a flexible pipe member so that the mass of the vessel is solely supported by the mass measuring device and solely allows axial movement of the vessel.

Preferably, in the system of the present invention the vessel is supported radially by bracketing that allows axial movement of the vessel.

It is also preferable that in the present invention the mass measuring device output can be used and manipulated for use with other peripheral apparatus.

It should be appreciated that the mass of the vessel, either with or without the support structure, may be measured or, in alternative, simply the change in the mass may be measured.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 is a drawing of a standard API Plan 53B system;

FIG. 2 is a drawing of a first preferred embodiment of the mass determination device in the form for use with an API Plan 53B system with four preferred embodiments of flexible pipe member design;

FIG. 3 is a drawing of a second preferred embodiment of the mass determination device in the form for use with an API Plan 53B system;

FIG. 4 is a drawing of third preferred embodiment of the mass determination device in the form for use with an API Plan 53B system; and,

FIG. 5 is a drawing of a fourth preferred embodiment of the mass determination device in the form for use with an API Plan 53B system.

### DETAILED DESCRIPTION OF THE DRAWING FIGURES AND PREFERRED EMBODIMENTS

The invention will now be described, by way of example only, with reference to the accompanying drawings:

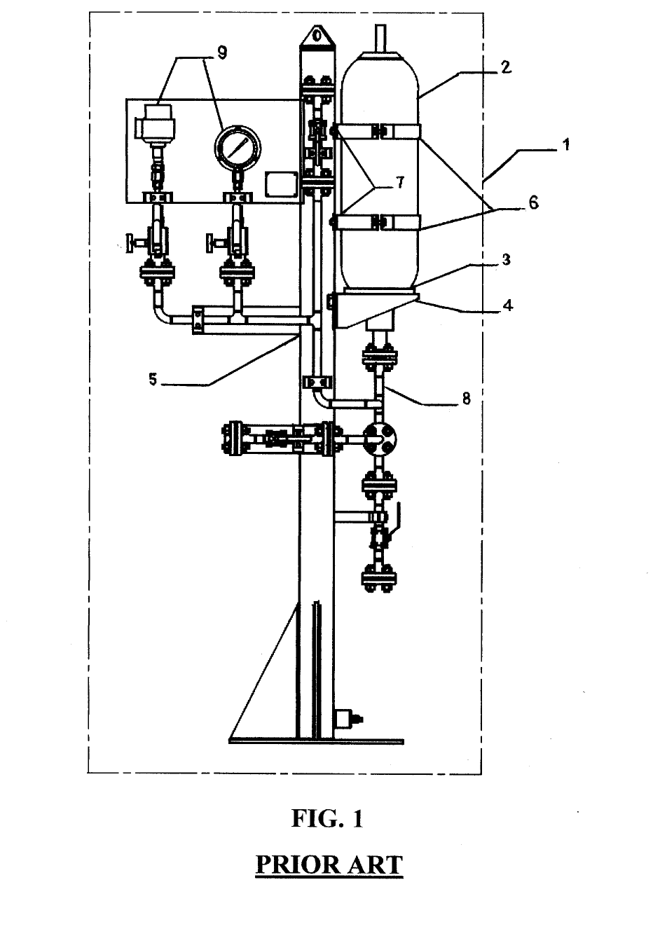

Turning now, in detail, to an analysis of the accompanying drawing figures, with reference to FIG. 1, the present invention relates to a pressure vessel mass determination device for use preferably with an API Plan 53B system 1. In a standard 53B system the vessel 2 is located on a cushion 3 and bracket 4 which, in turn, is fastened to a stand 5. Bracketing 6 is located circumferentially along the vessel 2 and connected, in turn, to the stand 5 at multiple juncture 7 to ensure that said vessel is radially supported. Pipe work 8 connects the vessel to various outlets and also pressure indication and transmitting devices 9. The pressure devices 9 indicate what pressure the barrier fluid resides at.

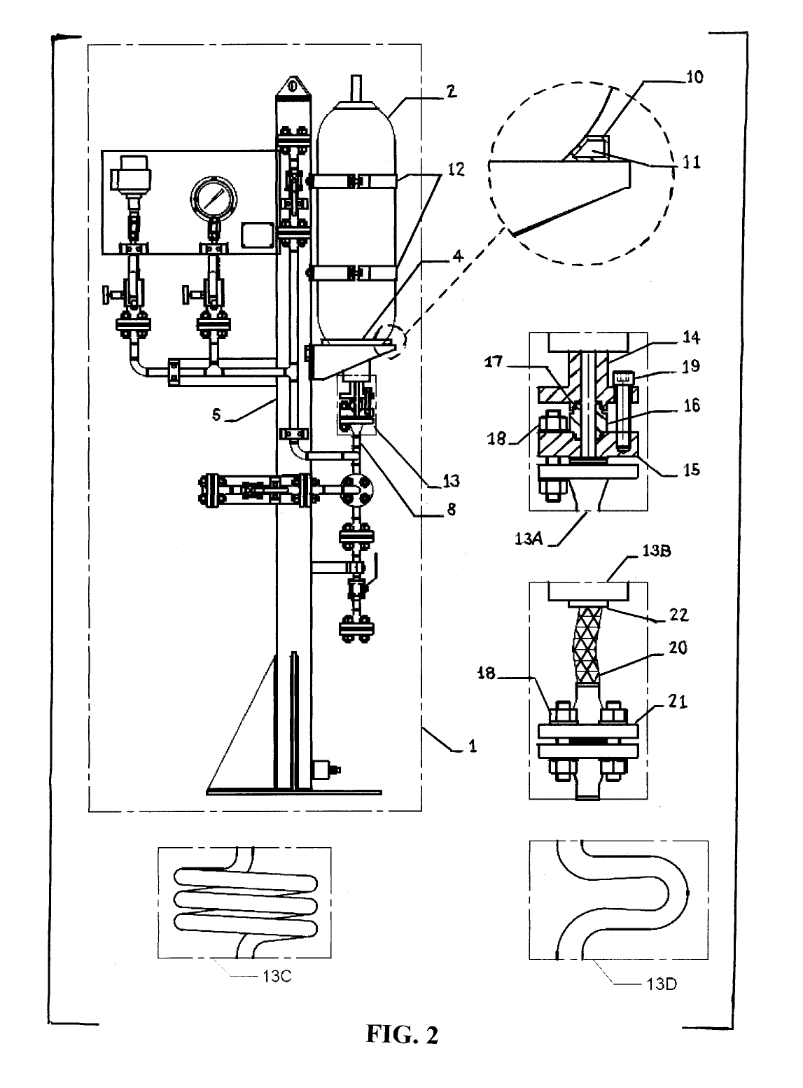

Referring to FIG. 2 of the accompanying drawings, a first preferred embodiment of a mass determination device of the present invention comprises a vessel 2 supported by a hollow cushioning member 10 having a cavity 11 in which resides a fluid to hydraulically transfer the mass of vessel 2 to a pressure measuring device which provides an output for manipulation to determine mass of the vessel and level of the fluid inside it. The vessel 2 is radially supported by bracketing 12, which allows axial movement of said vessel 2.

A flexible pipe member 13 allows axial movement of vessel 2 ensuring that the mass of the vessel 2 is transferred to the mass determination device in its entirety. The first embodiment of the flexible pipe member 13A is preferably, but not limited to, containing two flange plates; one of which is connected to the vessel 14 and the other to the system pipe work 15. In order to allow fluid continuity between said flange plates, a third member 16 resides with protrusions that interlock with the flange plates and provide cavitations for O-rings 17 to reside, thus sealing the barrier fluid from the atmosphere.

Preferably, the inclusion of orifices in the flange plates allow fastening to other pipe members by bolts 18. Fastening of secondary bolts 19 to a predetermined point between the flexible pipe flange plate members ensures that the vessel has limited axial movement, which ensures it cannot be removed from stand 5.

A second preferred embodiment of the flexible pipe member 13B is preferably, but not limited to, containing a flexible hose section 20 with a flanged end 21 for connection to the standard system pipe work 8 via bolts members 18, and a threaded boss end 22 for connection to vessel 2.

An alternative, preferred design of the flexible pipe member is shown in 13C, wherein a coil-shaped section of pipe is in place of a flexible hose section. As illustrated in 13D, the flexible pipe member may also be constructed so that it is a horizontally orientated “U”-shaped section, rather than coil-shaped. It is envisaged that any of these flexible pipe members can be used in conjunction with the vessel weighing means, such that the entire weight of the vessel is supported by the weighing means to give accurate measurements.

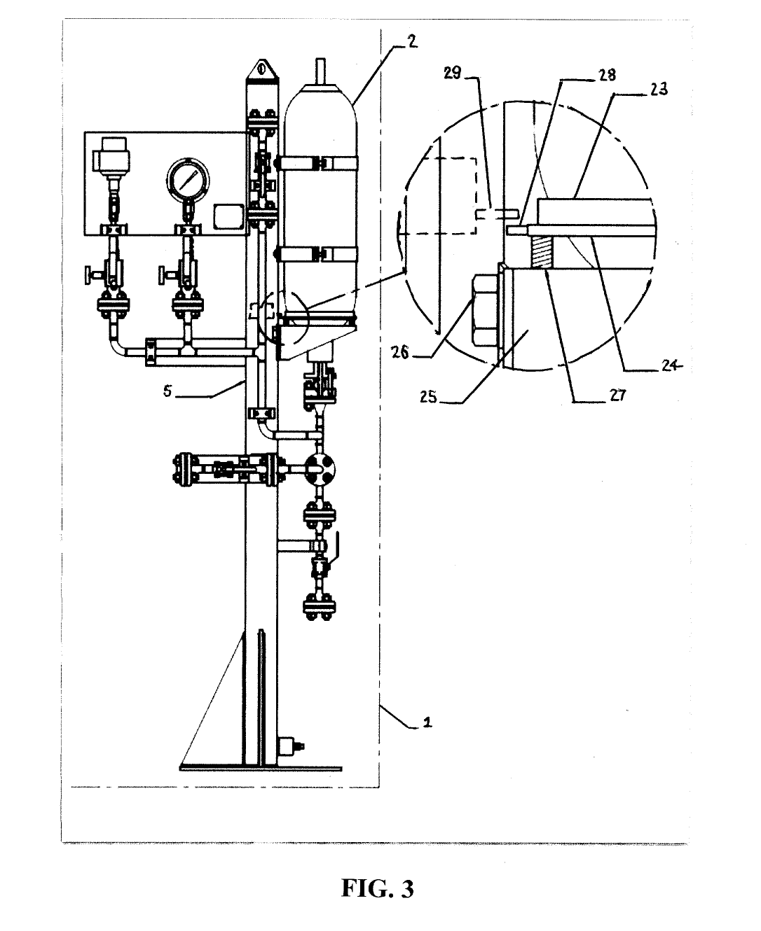

Referring to FIG. 3 of the accompanying drawing, a second preferred embodiment of a mass determination device of the invention comprises a vessel supported by a cushioning member 23, which is located on a plate 24 through which the vessel can protrude. The plate 24 is located on a bracket 25 which, in turn, is secured to the stand 5 via bolts 26. The plate 24 is secured to the bracket 25 by spring members 27, which are designed to support the mass of vessel 2 and compress to a desired level when the vessel is filled to the required volume. As the mass of the vessel reduces when the liquid volume reduces, so the springs 27 shall decompress. When the volume of fluid in the vessel has reduced to such an amount that it is necessary to be refilled, the springs 27 would have uncompressed to such an extent that a protruding member 28 provides an output that highlights that it is necessary to refill the vessel. This output may be in the form of contacting a switch member 29.

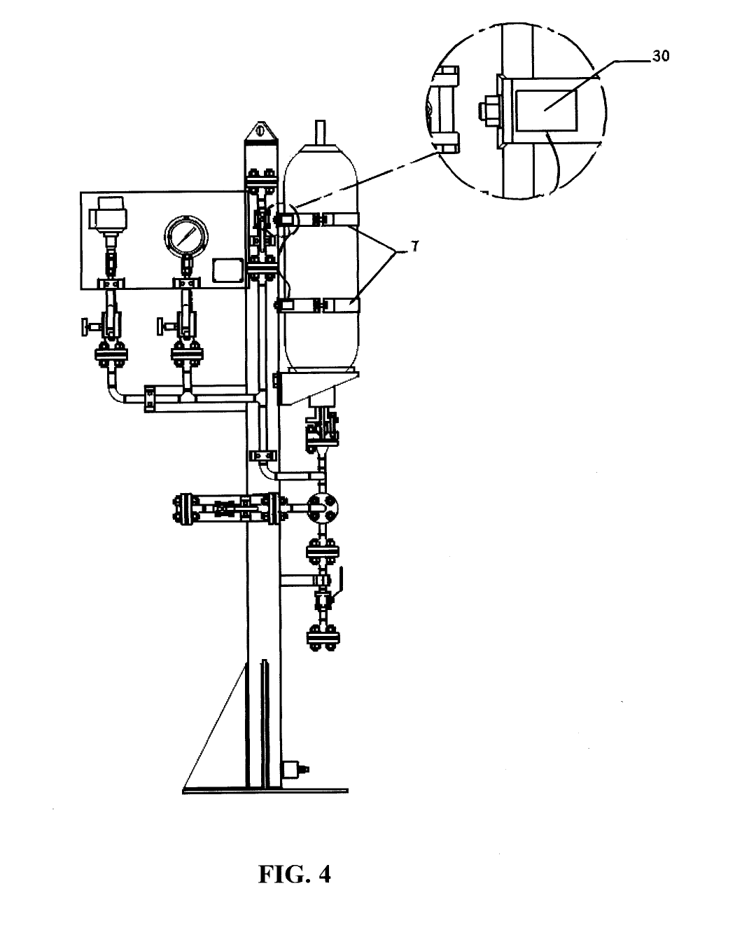

Referring to FIG. 4 of the accompanying drawings, a third preferred embodiment of a mass determination device of the present invention is shown, which comprises a vessel supported by the same means as the standard 53B system, illustrated in FIG. 1. Located on the bracketing 7 that ensures no radial movement of the vessel reside strain gauge members 30, which are connected to output means, allows the deflection in said bracket to be measured. The deflection will vary in degree depending on the mass of the vessel and so providing a differing output thus highlighting when the fluid in the vessel has reached such a level that it requires refilling.

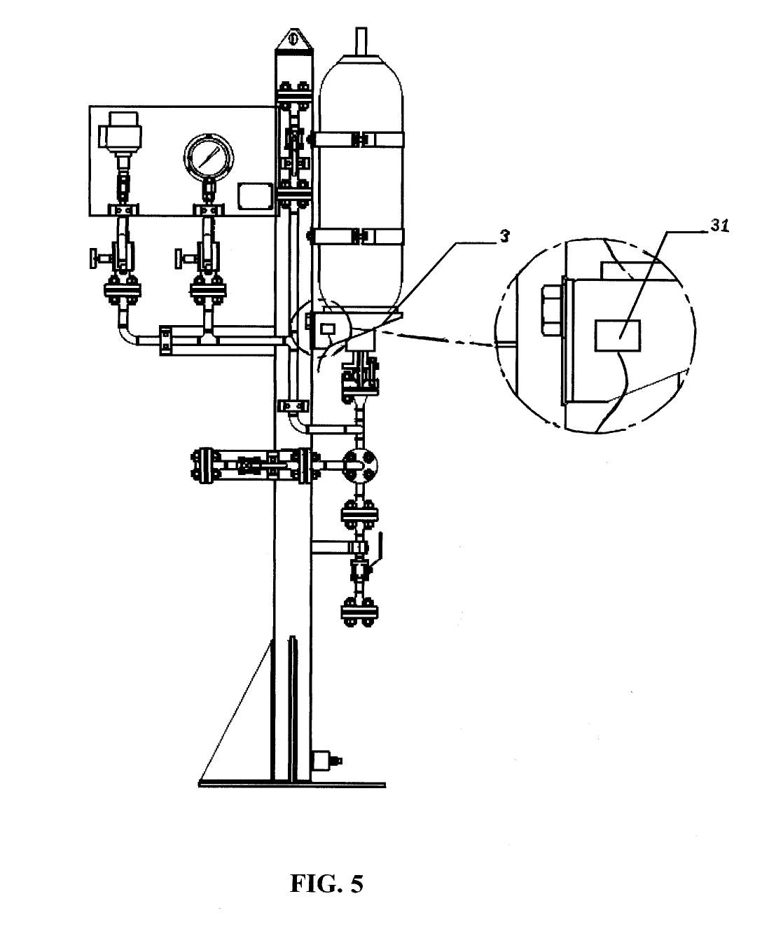

Referring to FIG. 5 of the accompanying drawings, a fourth preferred embodiment of a mass determination device of the present invention comprises a vessel supported by the same means as the standard 53B system, as shown in FIG. 1. Located on the cushion 3 that supports the mass of the vessel reside strain gauge members 31, which are connected to output means that allows the deflection in said bracket to be measured. The deflection will vary in degree depending on the mass of the vessel and so providing a differing output, thus highlighting when the fluid in the vessel has reached such a level that it requires refilling.

FIG. 5 further illustrates a fifth preferred embodiment of a mass determination device of the present invention, which comprises an arrangement similar to those described above. However in this preferred embodiment, the vessel and its support structure is arranged on a member 32, which is for instance a hollow cushioning device capable of transmitting mass, or change in mass, to a suitable pressure measuring device.

While only several embodiments of the present invention have been shown and described, it will be obvious to those skilled in the art that many modifications may be made to the present invention without departing from the spirit and scope thereof.

What is claimed is:

1. A mechanical seal support system, comprising:
a pressure vessel for supplying barrier fluid to a mechanical seal;
means for determining mass of said pressure vessel; and,
means for providing additional barrier fluid to said pressure vessel when a determined mass is below a predetermined level responsive to said means for determining mass of said pressure vessel.

2. The mechanical seal support system according to claim 1, further comprising:
means for holding said pressure vessel; and,
a support structure on which said means for holding said pressure vessel is mounted.

3. The mechanical seal support system according to claim 2, wherein said means for holding said pressure vessel is movable relative to said support structure.

4. The mechanical seal support system according to claim 2, further comprising:
a cushioning member containing a fluid; and,
means for determining pressure of said fluid for determining the mass of said pressure vessel.

5. The mechanical seal support system according to claim 2, wherein said means for holding said pressure vessel comprises a spring-mounted support plate.

6. The mechanical seal support system according to claim 5, further comprising a switch member for activating a signal for a requirement for adding said additional barrier fluid.

7. The mechanical seal support system according to claim 6, wherein said spring-mounted support plate is movable when the mass of said pressure vessel is less than the predetermined level to a position wherein said switch member is activated for providing the signal for adding said additional barrier fluid.

8. The mechanical seal support system according to claim 1, further comprising pipe work for connecting said pressure vessel to the mechanical seal, said pipe work including a flexible component.

9. The mechanical seal support system according to claim 8, wherein said flexible component including flange plates separated by a member having O-rings providing sealing therebetween.

10. The mechanical seal support system according to claim 8, wherein said flexible component comprises a flexible hose section.

11. The mechanical seal support system according to claim 8, wherein said flexible component comprises a coiled pipe section.

12. The mechanical seal support system according to claim 1, wherein said means for determining mass of said pressure vessel includes a strain gauge.

13. The mechanical seal support system according to claim 12, wherein said strain gauge is located on bracketing members surrounding said pressure vessel.

14. The mechanical seal support system according to claim 12, wherein said strain gauge is located on means for holding said pressure vessel.
